(19) United States
(12) Patent Application Publication
(10) Pub. No.: US 2009/0081911 A1
(43) Pub. Date: Mar. 26, 2009

(54) Antibacterial, waterproof, and absorbent composite cloth

(76) Inventor: Gary Keryi Yang, Simi Valley, CA (US)

Correspondence Address: REED SMITH LLP, Suite 1400, 3110 Fairview Park Drive, Falls Church, VA, 22042, US

(21) Appl. No.: 12/222,491

(22) Filed: Aug. 11, 2008

(30) Foreign Application Priority Data
Sep. 24, 2007 (CN) 200720114402.X

(51) Int. Cl. B32B 5/22; B32B 27/12

(52) U.S. Cl. 442/77; 442/118; 442/123; 442/86; 156/299

(57) ABSTRACT

An antibacterial, waterproof and absorbent composite clothe for making special disposable clothing such as surgical gowns. The composite cloth mainly contains a three-layer flexible laminate, namely a middle layer, an outer layer and an inner layer. The middle layer is substantially waterproof and air breathable. The middle layer has an inner side and an outer side on opposite sides thereof. The outer layer is made of antibacterial non-woven fabric to prevent bacteria from migrating through the cloth and is secured to the outer side of the middle layer. The inner layer is made of absorbent non-woven fabric to absorb sweat and is secured to the inner side of the middle layer.

### FIELD OF THE INVENTION

This invention relates generally to a composite cloth, in particular to an antibacterial, waterproof and absorbent composite cloth for making special disposable clothing and sheets such as surgical gowns, isolation clothing, hospital sheets and operation sheets to be worn or used by people in laboratories, hospitals, chemical factories and other special occasions.

### BACKGROUND OF THE INVENTION

The staff of hospitals, laboratories, and chemical factories is in frequent contact with virus, bacteria, blood, chemical reagents and toxic materials. Conventional protective clothing, surgical gowns, isolation clothing, hospital sheets and operation sheets are made of single-function cloth with single layer or multiple layers. Such conventional clothing is disposable after one use or is reusable through laundering thereof. However, they cannot simultaneously provide antibacterial, waterproof, and absorbent functions and thus have some disadvantages. For example, for clothing made of cloth that only provides antibacterial function, body liquid such as blood may penetrate and cause infection. For clothing made of cloth that only provides waterproof function, bacteria may migrate through and infect the wearer. Furthermore, in either of the above two cases, the wearer's sweat cannot be efficiently absorbed. As to clothing made of cloth that only provides absorbent function, bacteria, blood and toxic liquid may penetrate the cloth and contact the wearer and threaten his/her life.

Therefore, there exists a need for a composite cloth that simultaneously provides antibacterial, waterproof and absorbent functions.

### SUMMARY OF THE INVENTION

A primary object of the present invention is to provide an antibacterial, waterproof and absorbent composite cloth for making special disposable clothing such as surgical gowns, isolation clothing, hospital sheets and operation sheets to be worn or used by people in laboratories, hospitals, chemical factories and other special occasions. Another object of the present invention is to provide a method of making such a cloth.

The present invention in one embodiment relates to a composite cloth. The composite cloth mainly contains a three-layer flexible laminate, namely a middle layer, an outer layer and an inner layer. The middle layer is substantially waterproof and air breathable. The middle layer has an inner side and an outer side on opposite sides thereof. The outer layer is made of antibacterial non-woven fabric to prevent bacteria from migrating through the cloth and is secured to the outer side of the middle layer. The inner layer is made of absorbent non-woven fabric to absorb sweat and is secured to the inner side of the middle layer. The present invention in another embodiment relates to a method of manufacturing a composite cloth. The method comprises the steps of: providing a middle layer, which is substantially waterproof and air breathable and has an inner side and an outer side on opposite sides thereof; providing an outer layer made of antibacterial non-woven fabric to prevent bacteria from migrating through the cloth; providing an inner layer made of absorbent non-woven fabric to absorb sweat; securing the outer layer to the outer side of the middle layer; and securing the inner layer to the inner side of the middle layer.

### BRIEF DESCRIPTION OF THE DRAWINGS

The above objects and advantages of the present invention will become more apparent from the ensuing descriptions of preferred embodiments thereof with reference to the attached drawings, in which:

FIG. 1 is a schematic view of one embodiment of a composite cloth in accordance with the present invention; and

FIG. 2 is an enlarged fragmentary cross-sectional view taken along line A-A of FIG. 1.

### DETAILED DESCRIPTION OF THE PREFERRED EMBODIMENTS

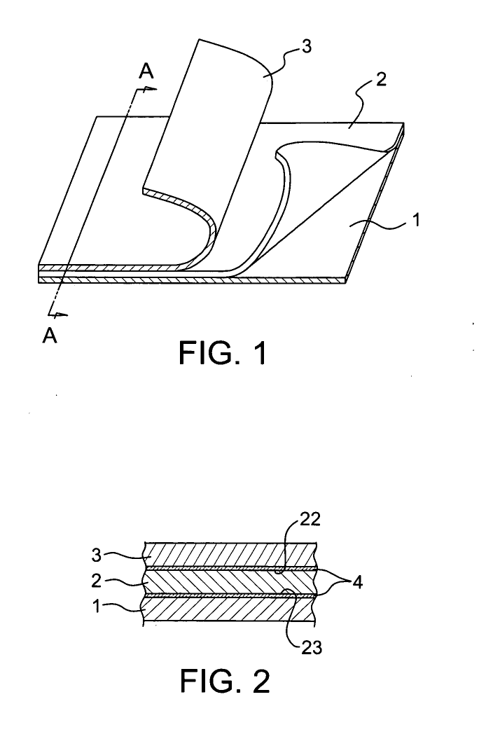

As shown in FIGS. 1-2, the composite cloth in accordance with the first embodiment mainly contains a three-layer flexible laminate, namely a middle layer 2, an outer layer 3 and an inner layer 1. The inner layer 1 is defined as the layer that faces the wearer, and the outer layer 3 is the opposite layer to the inner layer 1. The middle layer 2 is substantially micro-porous and thereby is waterproof and air breathable. The middle layer 2 can be made of Polyethylene (PP) film or Polyurethane (PU) film. The middle layer 2 has an inner side 23 and an outer side 22 on opposite sides thereof. The outer layer 3 is made of antibacterial non-woven fabric to prevent bacteria from migrating through the cloth and is secured to the outer side 22 of the middle layer 2. One of the specific materials of the outer layer 3 is antibacterial polypropylene spunbond fabric, which in addition to the antibacterial function also provides strength to the cloth. The inner layer 1 is made of absorbent non-woven fabric to absorb sweat and is secured to the inner side 23 of the middle layer 2. One of the specific materials of the inner layer 1 is ethylene-propylene side by side (ES), which in addition to the absorbent function also provides a soft-touch feeling.

The outer layer 3 is secured to the outer side 22 of the middle layer 2 and the inner layer 1 is secured to the inner side 23 of the middle layer 2 through adhesive layers 4. Alternatively, they may be secured through other methods, such as thermal bonding or press molding.

A second embodiment of the present invention relates to a method of manufacturing a composite cloth. The method comprises the steps of: (i) providing a middle layer 2 which is substantially waterproof and air breathable and has an inner side 23 and an outer side 22 on opposite sides thereof; (ii) providing an outer layer 3 made of antibacterial non-woven fabric to prevent bacteria from migrating through the cloth; (iii) providing an inner layer 1 made of absorbent non-woven fabric to absorb sweat; (iv) securing the outer layer 3 to the outer side 22 of the middle layer 2; and (v) securing the inner layer 1 to the inner side 23 of the middle layer 2.

Step (iv), securing the outer layer 3 to the outer side 22 of the middle layer 2, is to adhere the outer layer 3 to the outer side 22 of the middle layer 2, and step (v), securing the inner layer 1 to the inner side 23 of the middle layer 2, is to adhere the inner layer 1 to the inner side 23 of the middle layer 2. Alternatively, step (iv) can also be done with other methods, such as thermal bonding or press molding the outer layer 3 to the outer side 22 of the middle layer 2, and step (v) can be done with other methods, such as thermal bonding or press molding the inner layer 1 to the inner side 23 of the middle layer 2.

The middle layer 2 can be made of Polyethylene (PP) film or Polyurethane (PU) film and is substantially micro-porous. One of the specific materials of the antibacterial non-woven fabric is antibacterial polypropylene spunbond fabric and one of the specific materials of the absorbent non-woven fabric is ethylene-propylene side by side (ES).

The invention may also be implemented in other specific ways without departing from the spirit and the essence of the invention. Thus, the above-mentioned embodiments shall be regarded as explanatory but not restrictive. All changes consistent with the scope of the claims and the equivalents shall fall within the scope claimed by the invention.

We claim:

1. A composite cloth, comprising:
a middle layer, which is substantially waterproof and air breathable, said middle layer having an inner side and an outer side on opposite sides thereof;
an outer layer made of antibacterial non-woven fabric to prevent bacteria from entering said cloth, said outer layer being secured to said outer side of said middle layer; and
an inner layer made of absorbent non-woven fabric to absorb sweat, said inner layer being secured to said inner side of said middle layer.

2. The composite cloth of claim 1, wherein said middle layer is made of Polyethylene (PP) film.

3. The composite cloth of claim 1, wherein said middle layer is made of Polyurethane (PU) film.

4. The composite cloth of claim 1, wherein said antibacterial non-woven fabric is antibacterial polypropylene spunbond fabric.

5. The composite cloth of claim 1, wherein said absorbent non-woven fabric is ethylene-propylene side by side (ES).

6. The composite cloth of claim 1, wherein said outer layer is secured to said outer side of said middle layer and said inner layer is secured to said inner side of said middle layer through adhesive layers.

7. The composite cloth of claim 1, wherein said middle layer is substantially micro-porous.

8. A method of manufacturing a composite cloth, comprising the steps of:
providing a middle layer, which is substantially waterproof and air breathable and has an inner side and an outer side at opposite sides thereof;
providing an outer layer made of antibacterial non-woven fabric to prevent bacteria from penetrating said cloth;
providing an inner layer made of absorbent non-woven fabric to absorb sweat;
securing said outer layer to said outer side of said middle layer; and
securing said inner layer to said inner side of said middle layer.

9. The method of claim 8, wherein said step of securing said outer layer to said outer side of said middle layer is to adhere said outer layer to said outer side of said middle layer, and said step of securing said inner layer to said inner side of said middle layer is to adhere said inner layer to said inner side of said middle layer.

10. The method of claim 8, wherein said step of securing said outer layer to said outer side of said middle layer is to thermal bond said outer layer to said outer side of said middle layer, and said step of securing said inner layer to said inner side of said middle layer is to thermal bond said inner layer to said inner side of said middle layer.

11. The method of claim 8, wherein said step of securing said outer layer to said outer side of said middle layer is to press mold said outer layer to said outer side of said middle layer, and said step of securing said inner layer to said inner side of said middle layer is to press mold said inner layer to said inner side of said middle layer.

12. The method of claim 8, wherein said middle layer is made of Polyethylene (PP) film.

13. The method of claim 8, wherein said middle layer is made of Polyurethane (PU) film.

14. The method of claim 8, wherein said antibacterial non-woven fabric is antibacterial polypropylene spunbond fabric.

15. The method of claim 8, wherein said absorbent non-woven fabric is ethylene-propylene side by side (ES).

16. The method of claim 8, wherein said middle layer is substantially micro-porous.
